(19) United States
(12) Patent Application Publication
(10) Pub. No.: US 2014/0028537 A1
(43) Pub. Date: Jan. 30, 2014

(54) LIQUID CRYSTAL PANEL AND MANUFACTURING METHOD THEREOF

(71) Applicants: Tao Song, Shenzhen (CN); Guodong Zhao, Shenzhen (CN); Ming Liu, Shenzhen (CN)

(72) Inventors: Tao Song, Shenzhen (CN); Guodong Zhao, Shenzhen (CN); Ming Liu, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/697,532

(22) PCT Filed: Aug. 10, 2012
(86) PCT No.: PCT/CN2012/079941

§ 371 Date: Nov. 13, 2012

(30) Foreign Application Priority Data
Jul. 24, 2012 (CN) 201210257772.4

(51) Int. Cl. G02F 1/1333; G09G 3/36

(52) U.S. Cl. CPC G02F 1/1333; G09G 3/36
USPC 345/98; 29/25.01

(57) ABSTRACT

A liquid crystal panel includes an array substrate. The array substrate forms a peripheral circuit area including a COF module crimping area and a shorting bar area located outside the COF module crimping area, the shorting bar area forming at least one detecting circuit being connected to scan lines or data lines on the array substrate and being removed after the liquid crystal panel is detected. In the present disclosure, the at least one detecting circuit formed in the shorting bar area is removed after the liquid crystal panel is detected, thus, a safe area and a laser cutting area located outside the COF module crimping area can be omitted to improve the utilization rate of the liquid crystal panel.

### BACKGROUND

1. Technical Field

The present disclosure relates to technologies of liquid crystal panels and, particularly, to a liquid crystal panel and a manufacturing method thereof.

2. Description of Related Art

Liquid Crystal Display (LCD) is a Flat Panel Display (FPD) that uses the characteristics of liquid crystal to display image. Compared to other types of display, LCD is thin and it requires lower driving voltage and lower power consumption, which makes it the mainstream product in the consumer goods market.

Liquid crystal panel is the main component of LCD. The manufacturing process of the liquid crystal panel generally includes an earlier array manufacturing process, a middle bonding process, and a later moduling process. In order to reduce the difficulty of detecting images of the liquid crystal panel in the bonding process and reduces facility cost, a shorting bar is generally used for detecting the images of the liquid crystal panel. Referring to FIG. 1, which is a schematic view of a present detecting circuit of a liquid crystal panel. In the earlier array manufacturing process, when a thin film transistor (TFT) effective displaying area and peripheral circuits of the TFT effective displaying area are formed, some detecting circuits, including but not limited to a detecting circuit D1 of the first data line, a detecting circuit D2 of the second data line, a detecting circuit G of the scan line, and a detecting circuit C of the common electrode, are often disposed outside the scan lines and data lines on the array substrate. The detecting circuits are respectively connected to the corresponding data line or scan line and are partly or all short circuited to each other, thereby detecting the array substrate in the earlier array manufacturing process and detecting the images of the liquid crystal panel in the bonding process.

Referring to FIG. 2, which is a schematic view showing the process of cutting the detecting circuits by laser. After finishing detecting the images of the liquid crystal panel, connecting portions between the detecting circuits and the corresponding scan line or data line are cut by laser. Being restricted by the present cutting precision, a width of the portion 5, which is located in a laser cutting area 1 and removed by laser, ranges from 30 um to 120 um. Therefore, in the later moduling process, in order to prevent metal portions of other components such as chips used in the COF moduling process from being short circuited to the detecting circuits which may cause undesirable displaying of the liquid crystal panel, a safe area 3 is formed between the laser cutting area 1 and a COF module crimping area 2 where the COF is mounted.

In the above structure of the liquid crystal panel, a number of extra areas are formed on the liquid crystal panel outside the COF module crimping area 2 in which the COF is crimped, which results in the waste of the liquid crystal panel and reduces the utilization rate of the liquid crystal panel.

### SUMMARY

The present disclosure provides a liquid crystal panel. The liquid crystal panel includes an array substrate. The array substrate forms a peripheral circuit area which includes a COF module crimping area and a shorting bar area located outside the COF module crimping area. The shorting bar area forms at least one detecting circuit being connected to scan lines or data lines on the array substrate and being removed after the liquid crystal panel is detected.

Preferably, a precision reserving area is formed between the COF module crimping area and the shorting bar area.

Preferably, a width of the shorting bar area ranges from 150 um to 350 um.

Preferably, the width of the precision reserving area ranges from 30 um to 50 um.

Preferably, the at least one detecting circuit formed in the shorting bar area includes a first detecting circuit and a second detecting circuit, the first detecting circuit is connected to the data lines, and the second detecting circuit is connected to the scan lines.

Preferably, the at least one detecting circuit is further connected to gates of TFTs on the array substrate.

Preferably, the width of the shorting bar area ranges from 150 um to 350 um.

Preferably, the width of the shorting bar area ranges from 150 um to 350 um.

The present disclosure further provides a manufacturing method of a liquid crystal panel, includes:

manufacturing a TFT array substrate forming an effective displaying area and a peripheral circuit area which includes a COF module crimping area and a shorting bar area located outside the COF module crimping area;

forming at least one detecting circuit in the shorting bar area connected to scan lines or data lines on the array substrate; and

removing the at least one detecting circuit in the shorting bar area by laser after detects on the liquid crystal panel are finished.

Preferably, the manufacturing method further includes the following step after the step of forming at least one detecting circuit in the shorting bar area connected to scan lines or data lines on the array substrate:

forming a precision reserving area between the COF module crimping area and the shorting bar area.

Preferably, a width of the shorting bar area ranges from 150 um to 350 um.

Preferably, the width of the precision reserving area ranges from 30 um to 50 um.

Preferably, the at least one detecting circuit includes a first detecting circuit and a second detecting circuit, the first detecting circuit is connected to the data lines and the second detecting circuit is connected to the scan lines.

Preferably, the shorting bar forms at least one detecting circuit, and the manufacturing method further includes the step after the step of forming at least one detecting circuit in the shorting bar area connected to scan lines or data lines on the array substrate:

further connecting the at least one detecting circuit to gates of TFTs on the array substrate.

Preferably, the width of the shorting bar area ranges from 150 um to 350 um.

Preferably, the width of the shorting bar area ranges from 150 um to 350 um.

In the present disclosure, the at least one detecting circuit formed in the shorting bar area is removed after the liquid crystal panel is detected, thus, a safe area and a laser cutting area located outside the COF module crimping area can be omitted to improve the utilization rate of the liquid crystal panel.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a present detecting circuit of a liquid crystal panel;

FIG. 2 is a schematic view showing the process of cutting the detecting circuit of the liquid crystal panel by laser;

FIG. 3 is a schematic view of a liquid crystal panel in accordance with an embodiment of the present disclosure;

FIG. 4 is a schematic view of a liquid crystal panel in accordance with another embodiment of the present disclosure;

FIG. 5 is a flow chart of a manufacturing method of the liquid crystal panel in accordance with an embodiment of the present disclosure.

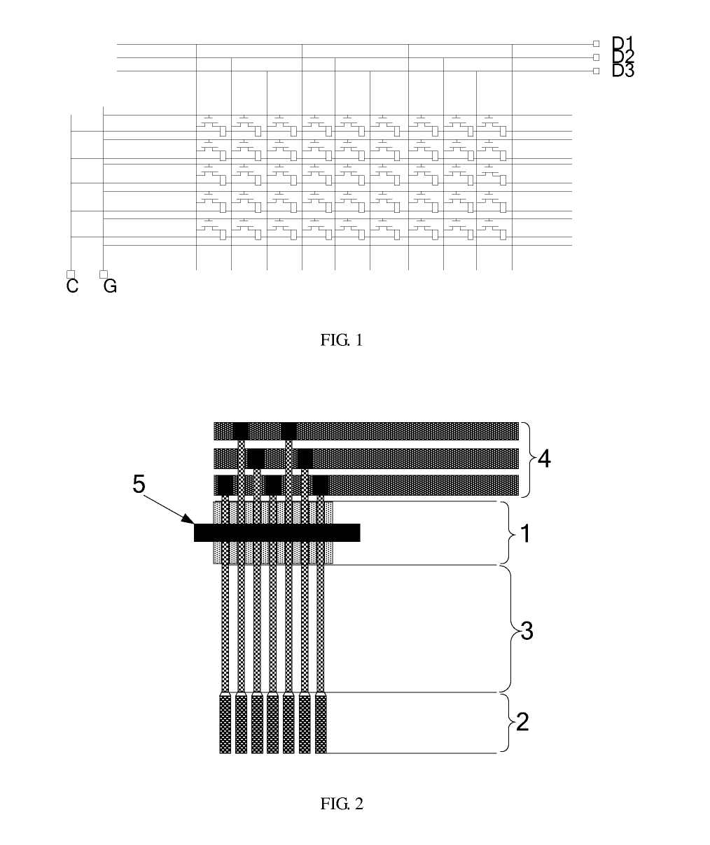

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

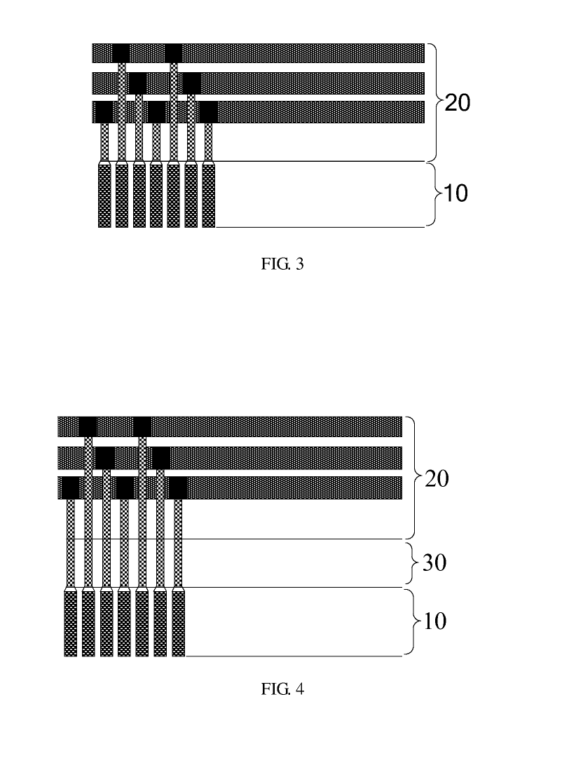

Referring to FIG. 3, a liquid crystal panel in accordance with an embodiment of the present disclosure, is schematically shown. The liquid crystal panel includes an array substrate. The array substrate has a peripheral circuit area, which includes a COF module crimping area 10 and a shorting bar area 20 located outside the COF module crimping area 10. At least one detecting circuit is formed in the COF module crimping area 10. The at least one detecting circuit is connected to scan lines or data lines on the array substrate and is removed by layer after the liquid crystal panel is detected.

Specifically, the liquid crystal panel includes the array substrate, a CF substrate, and liquid crystal disposed between the array substrate and the CF substrate. A glass substrate is filmed, developed, etched to form the array substrate having an effective displaying area and the peripheral circuit area. The peripheral circuit area includes the COF module crimping area 10 and the shorting bar area 20. In the later moduling process, a driving IC is crimped in the COF module crimping area 10 and is connected to the TFTs, scan lines, and data lines on the array substrate. The shorting bar area 20 forms at least one detecting circuit which is connected to the scan lines or data lines on the array substrate, thereby at least partly short circuiting the data lines or data lines connected thereto. The shorting bar area 20 can further form detecting circuits connected to gate lines of the TFTs on the substrate. The detecting circuits in the shorting bar area 20 are mainly used for detecting the circuit on the array substrate in the earlier array manufacturing process and for detecting images of the liquid crystal panel in the bonding process.

However, after the circuit on the array substrate and the images of the liquid crystal panel are detected, the detecting circuits formed in the shorting bar area 20 are removed by laser to prevent the detecting circuits from being short circuited to the other circuits of array substrate. The shorting bar area 20 has a width ranging from 150 um to 350 um. Since the detecting circuits in the shorting bar area 20 are removed by laser, thus, when manufacturing the COF module in the later moduling process, the components such as the COF can be prevented from being connected to the other circuits (mainly the detecting circuits formed in the shorting bar area). In this way, a safe area outside the COF module crimping area can be omitted, which improves the utilization rate of the liquid crystal panel.

In the present disclosure, the detecting circuits formed in the shorting bar area are removed by laser, and the extra safe area and laser cutting area outside the COF module crimping area can be omitted, which improves the utilization rate of the liquid crystal panel.

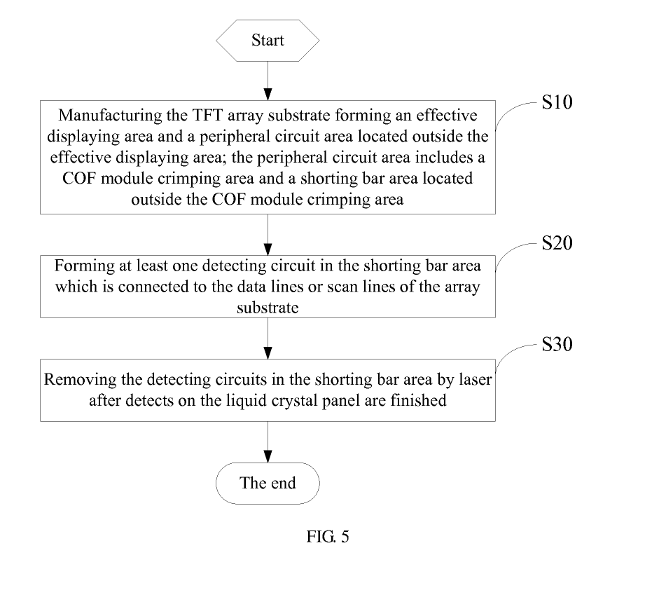

Furthermore, referring to FIG. 4, a liquid crystal panel in accordance with another embodiment of the present disclosure, is schematically shown. The liquid crystal panel of the second embodiment is similar to that of the first embodiment, and the difference therebetween lies in that, the liquid crystal panel of the second embodiment further includes a precision reserving area 30 formed between the COF module crimping area 10 and the shorting bar area 20. In order to improve the yielding rate of the liquid crystal panel, the precision reserving area 30 is formed between the COF module crimping area 10 and the shorting bar area 20, thereby preventing the COF module crimping area 10 from being removed by laser due to low laser cutting precision while the detecting circuits in the shorting bar area 20 are removed by laser. In the embodiment, the width of the precision reserving area 30 ranges from 30 um to 50 um.

Furthermore, the detecting circuits formed in the shorting bar area 30 include a first detecting circuit and a second detecting circuit. The first detecting circuit is connected to the data lines on the array substrate and at least partly short circuits the data lines. The second detecting circuit is connected to the scan lines on the array substrate and at least partly short circuits the scan lines.

Furthermore, the detecting circuits formed in the shorting bar area 30 further include a third detecting circuit. The third detecting circuit is connected to the gates of TFTs on the array substrate.

Referring to FIG. 5, which is a flow chart of a manufacturing method of the liquid crystal panel. The manufacturing method includes the following steps:

Step S10, manufacturing the TFT array substrate forming an effective displaying area and a peripheral circuit area located outside the effective displaying area; the peripheral circuit area includes a COF module crimping area and a shorting bar area located outside the COF module crimping area.

A glass substrate is filmed, developed, and etched to form the array substrate having the effective displaying area and the peripheral circuit area. The peripheral circuit area includes the COF module crimping area 10 and the shorting bar area 20. In the later moduling process, a driving IC is crimped in the COF module crimping area 10 and thus is disposed on the array substrate to be connected to the TFTs, data lines, and scan lines on the array substrate.

Step S20, forming at least one detecting circuit in the shorting bar area which is connected to the data lines or scan lines on the array substrate.

The at least one detecting circuit formed in the shorting bar area 20 is connected to the scan lines or data lines on the array substrate, thereby at least partly short circuiting the data lines or scan lines connected thereto. The shorting bar area can further form other detecting circuits connected to gates of the TFTs. The detecting circuits formed in the shorting bar area are mainly used for detecting other circuits on the array substrate in the array manufacturing process and for detecting images of the liquid crystal panel in the bonding process.

Step S30, removing the detecting circuits in the shorting bar area by laser after detects on the liquid crystal panel are finished.

After the detects on the liquid crystal panel are finished, the detecting circuits disposed in the shorting bar area 20 are removed by laser to prevent the detecting circuit from being short circuited to other circuits on the array substrate. Since the detecting circuits are removed by laser, therefore, when manufacturing the COF module in the later moduling process, components like COF are prevented from being connected to the other circuits (mainly the detecting circuits formed in the shorting bar area) located outside the COD module crimping area 10. In this way, a safe area located outside the COF module crimping area 10 can be omitted, which improves the utilization rate of the liquid crystal panel.

In the manufacturing method of the present disclosure, the detecting circuits disposed in the shorting bar area are removed by laser, therefore, the safe area and a layer cutting area located outside the COD module crimping area can be omitted, which improves the utilization rate of the liquid crystal panel.

Furthermore, in the above step S10, when manufacturing the array substrate, a precision reserving area 30 is formed between the COF module crimping area and the shorting bar area. In order to improve the yielding rate of the liquid crystal panel, the precision reserving area 30 is formed between the COF module crimping area 10 and the shorting bar area 20, thereby preventing the COF module crimping area 10 from being removed by laser due to low laser cutting precision while the detecting circuits in the shorting bar area 20 are removed by laser. In the embodiment, the width of the precision reserving area 30 ranges from 30 um to 50 um.

Furthermore, the detecting circuits formed in the shorting bar area 30 include a first detecting circuit and a second detecting circuit. The first detecting circuit is connected to the data lines on the array substrate and at least partly short circuits the data lines. The second detecting circuit is connected to the scan lines on the array substrate and at least partly short circuits the scan lines.

Furthermore, the detecting circuits formed in the shorting bar area 30 further include a third detecting circuit. The third detecting circuit is connected to the gates of TFTs on the array substrate.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal panel, comprising an array substrate, the array substrate forming a peripheral circuit area comprising a COF module crimping area and a shorting bar area located outside the COF module crimping area, the shorting bar area forming at least one detecting circuit being connected to scan lines or data lines on the array substrate and being removed after the liquid crystal panel is detected.

2. The liquid crystal panel as claimed in claim 1, wherein a precision reserving area is formed between the COF module crimping area and the shorting bar area.

3. The liquid crystal panel as claimed in claim 2, wherein a width of the shorting bar area ranges from 150 um to 350 um.

4. The liquid crystal panel as claimed in claim 2, wherein the width of the precision reserving area ranges from 30 um to 50 um.

5. The liquid crystal panel as claimed in claim 1, wherein the at least one detecting circuit formed in the shorting bar area comprises a first detecting circuit and a second detecting circuit, the first detecting circuit is connected to the data lines, and the second detecting circuit is connected to the scan lines.

6. The liquid crystal panel as claimed in claim 1, wherein the at least one detecting circuit is further connected to gates of TFTs on the array substrate.

7. The liquid crystal panel as claimed in claim 6, wherein the width of the shorting bar area ranges from 150 um to 350 um.

8. The liquid crystal panel as claimed in claim 1, wherein the width of the shorting bar area ranges from 150 um to 350 um.

9. A manufacturing method of a liquid crystal panel, comprising:
manufacturing a TFT array substrate forming an effective displaying area and a peripheral circuit area which comprises a COF module crimping area and a shorting bar area located outside the COF module crimping area;
forming at least one detecting circuit in the shorting bar area connected to scan lines or data lines on the array substrate; and
removing the at least one detecting circuit in the shorting bar area by laser after detects on the liquid crystal panel are finished.

10. The manufacturing method as claimed in claim 9 further comprising the following step after the step of forming at least one detecting circuit in the shorting bar area connected to scan lines or data lines on the array substrate:
forming a precision reserving area between the COF module crimping area and the shorting bar area.

11. The manufacturing method as claimed in claim 10, wherein a width of the shorting bar area ranges from 150 um to 350 um.

12. The manufacturing method as claimed in claim 10, wherein the width of the precision reserving area ranges from 30 um to 50 um.

13. The manufacturing method as claimed in claim 9, wherein the at least one detecting circuit comprises a first detecting circuit and a second detecting circuit, the first detecting circuit is connected to the data lines and the second detecting circuit is connected to the scan lines.

14. The manufacturing method as claimed in claim 9, wherein the shorting bar forms at least one detecting circuit, and the manufacturing method further comprises the step after the step of forming at least one detecting circuit in the shorting bar area connected to scan lines or data lines on the array substrate:
further connecting the at least one detecting circuit to gates of TFTs on the array substrate.

15. The manufacturing method as claimed in claim 14, wherein the width of the shorting bar area ranges from 150 um to 350 um.

16. The manufacturing method as claimed in claim 9, wherein the width of the shorting bar area ranges from 150 um to 350 um.
